(19) United States
(12) Patent Application Publication
(10) Pub. No.: US 2015/0000103 A1
(43) Pub. Date: Jan. 1, 2015

(54) Pulling Eye Insert

(71) Applicant: Panduit Corp., Tinley Park, IL (US)

(72) Inventors: William F. McAvoy, Des Plaines, IL (US); Edward F. Kirn, Tinley Park, IL (US)

(21) Appl. No.: 13/927,239

(22) Filed: Jun. 26, 2013

(51) Int. Cl. G02B 6/44

(52) U.S. Cl. CPC G02B 6/4479; G02B 6/4477
USPC 29/447; 29/244; 29/428

(57) ABSTRACT

A pulling eye insert to be used as part of a pulling assembly for pre-connectorized fiber-optic cable is described. The pulling eye insert has a channel configured to encircle the cable integrally connected to a cup configured to enclose and engage a transition of the pre-connectorized cable. In one embodiment, the pulling eye insert, can be formed of two indentical halves, each half having a raised ridge and groove on opposite end faces of the semi-cylindrical wall which forms the channel.

### FIELD OF THE INVENTION

The present invention relates generally to pulling assemblies for fiber optic cable and specifically, to an insert for a pulling assembly for pre-connectorized fiber-optic cable.

### BACKGROUND OF THE INVENTION

Often pre-connectorized fiber-optic cable must be installed through conduit or under a raised floor. Currently, this process is usually performed using a mesh pulling sleeve. However, this method generally places the pulling load or strain on the jacket of the cable which can damage the jacket.

### SUMMARY OF THE INVENTION

This application describes a pulling eye insert to be used as part of a pulling assembly for pre-connectorized fiber-optic cable. The pulling eye insert has a channel configured to encircle the cable integrally connected to a cup configured to enclose and engage a transition of the pre-connectorized cable. In one embodiment, the pulling eye insert can be formed of two identical halves, each half having a raised ridge and groove on opposite end faces of the semi-cylindrical wall which forms the channel.

### BRIEF DESCRIPTION OF FIGURES

FIG. 1 is a perspective view of a pulling eye insert for a pulling assembly.

FIG. 2 is an exploded perspective view of the pulling eye insert of FIG. 1 showing the two identical halves that make up the pulling eye insert.

FIG. 3 is a magnified perspective view of the end of one of the pulling eye insert halves of FIG. 2.

FIG. 4 is a cross-sectional view of one of the pulling eye insert halves of FIG. 2 taken along line 4-4 of FIG. 2.

FIG. 5 is an exploded perspective view of a pulling assembly using the pulling eye insert of FIG. 1.

FIG. 6 is a perspective view of a partially assembled pulling assembly of FIG. 5.

FIG. 7 is a perspective view of a fully assembled pulling assembly of FIG. 5.

FIG. 8 is a perspective view of a transition of a cable.

FIG. 9 is a perspective view of the transition of FIG. 8 before the breakout tubes are placed over the stripped fibers.

FIG. 10 is a perspective view of the transition of FIG. 8 after the breakout tubes are placed over the stripped fibers.

FIG. 11 is a cross-sectional view of the transition of FIG. 8 taken along line 11-11 of FIG. 8.

FIG. 12 is a cross-sectional view of the transition of FIG. 8 taken along line 12-12 of FIG. 8.

FIG. 13 is a cross-sectional view of the pulling assembly of FIG. 6 taken along line 13-13 of FIG. 6.

FIG. 14 is a cross-sectional view of the pulling assembly of FIG. 6 taken along line 14-14 of FIG. 13.

### DETAILED DESCRIPTION OF THE PREFERRED EMBODIMENTS

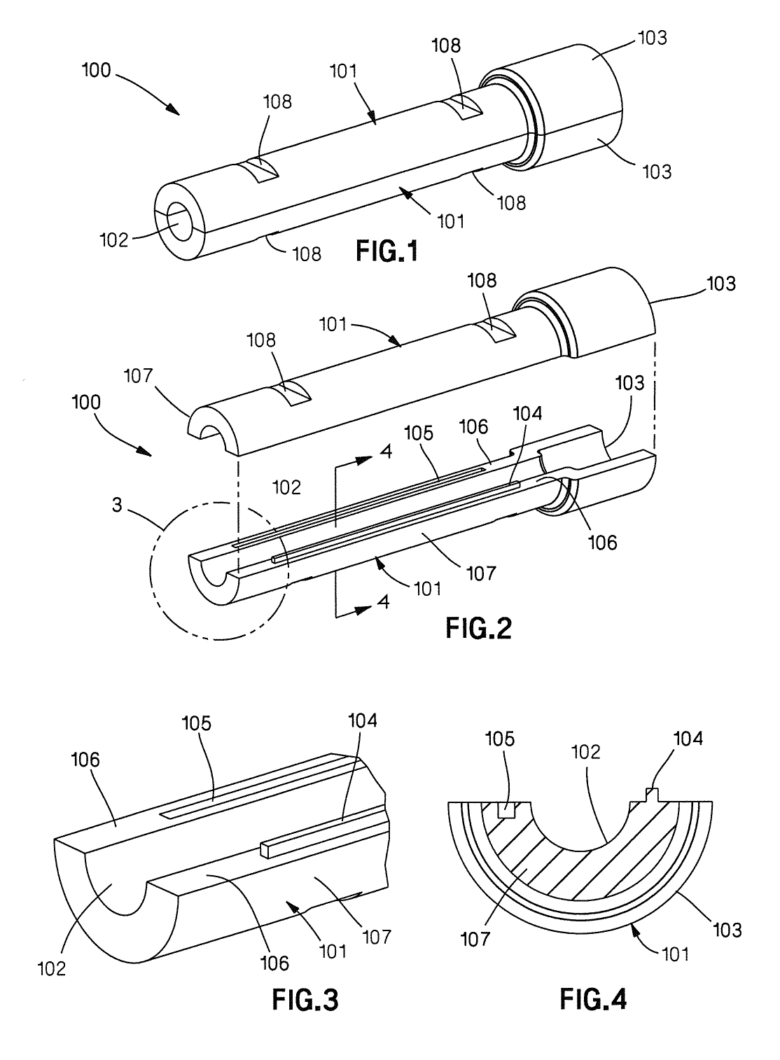

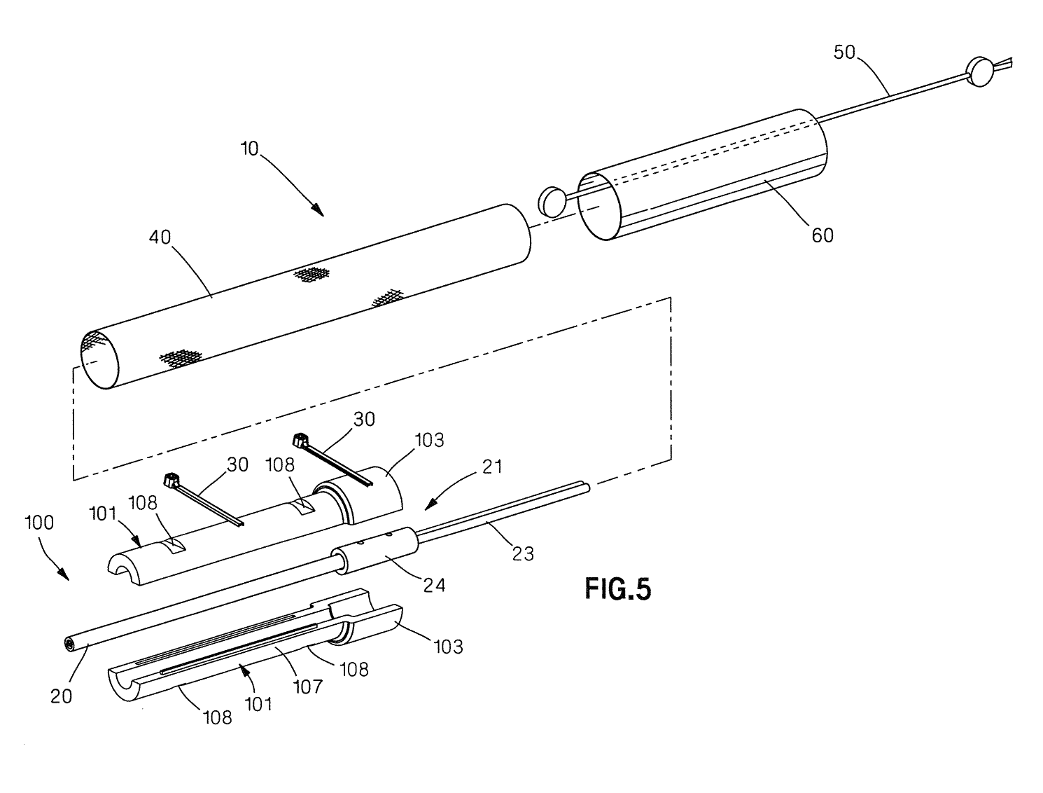

FIGS. 1-4 show one embodiment of a pulling eye insert 100 for a pulling assembly. As best shown in FIG. 2, the pulling eye insert 100 is made up of two identical halves 101. When the halves 101 are joined together (as shown in FIG. 1) they form a long cylindrical channel 102 with a cup 103 at one end. The diameter of the cup 103 is larger than the diameter of the cylindrical channel 102.

As shown in FIGS. 2 and 3, each half of the pulling eye insert 101 has a raised ridge 104 and a groove 105 on opposite end faces 106 of the semi-cylindrical wall 107 that forms the channel 102. This allows the raised ridge 104 of each pulling eye insert half 101 to engage the groove 105 of the other half when the two halves are joined together. In some embodiments, the pulling eye insert 100 can have notches 108 formed in the outer surface of the semi-cylindrical wall 107.

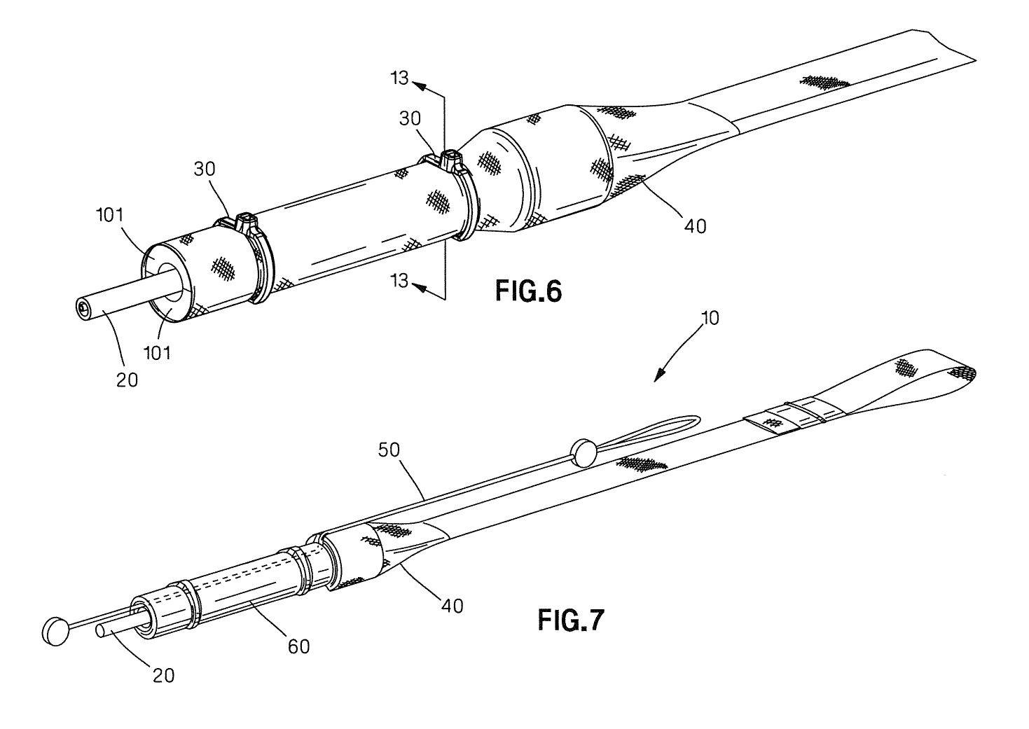

As shown in FIGS. 5-7, the pulling eye insert 100 can be used as part of a pulling assembly 10 for a fiber optic cable 20. In one embodiment, the pulling assembly 10 includes the pulling eye insert 100, fiber optic cable 20, nylon ties 30, flexible sleeve 40, lanyard 50, and heat shrink 60. The pulling eye insert halves 101 enclose the cable 20 at a transition 21 such that the cup of the pulling eye insert 100 encloses and engages the transition 21 of the cable. The flexible sleeve 40 is then placed over the fiber optic cable 20 and the pulling eye insert 100 (the flexible sleeve can also enclose any connectors, and break-out cables that are connected after the transition 21). As shown in FIG. 6, the nylon ties 30 can enclose the flexible sleeve 40 and pulling eye insert 100. In one embodiment, the nylon ties 30 can partially sit within the notches 108 of the pulling eye insert 100. Finally, a heat shrink 60 can enclose the rest of the assembly and an optional lanyard 50 to complete the pulling assembly 10.

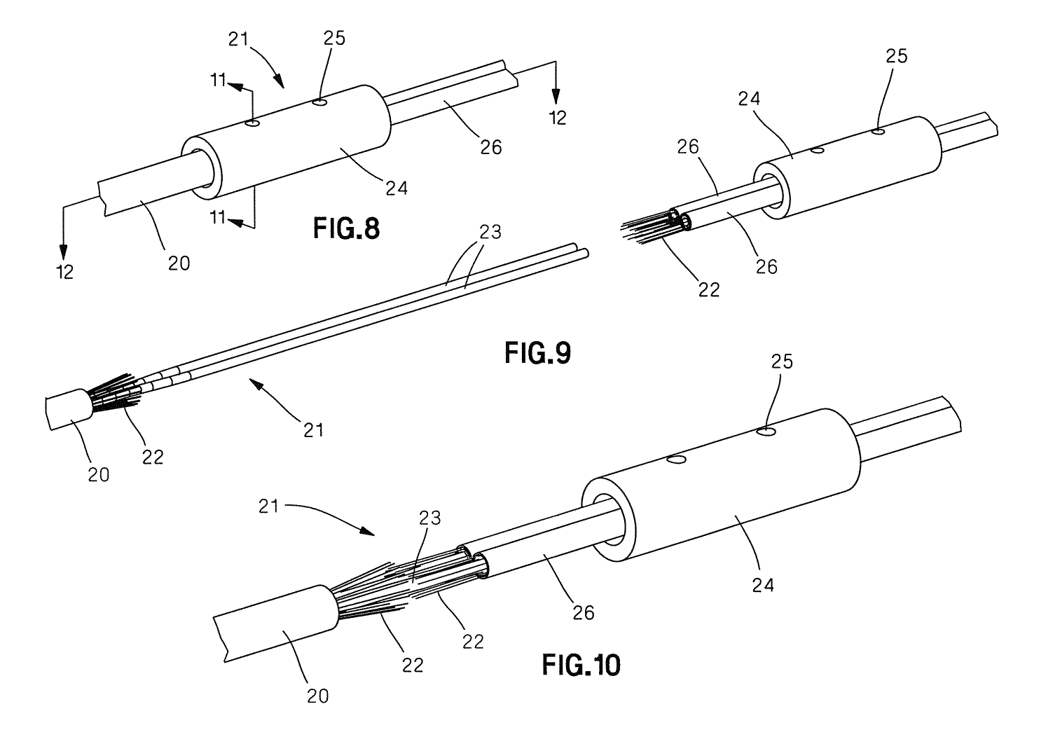

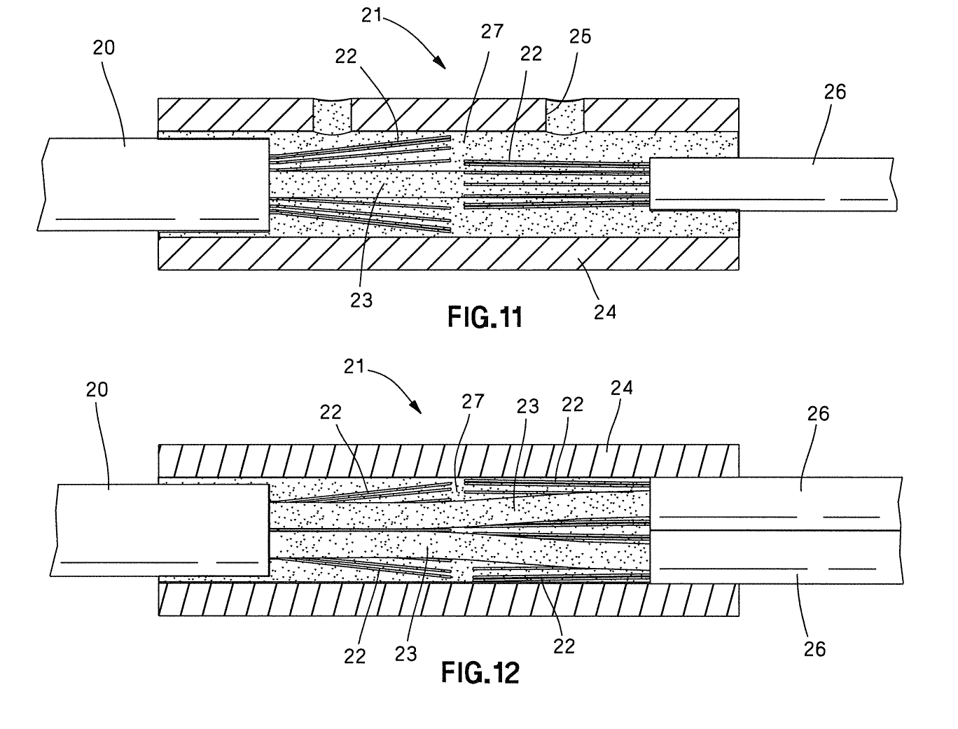

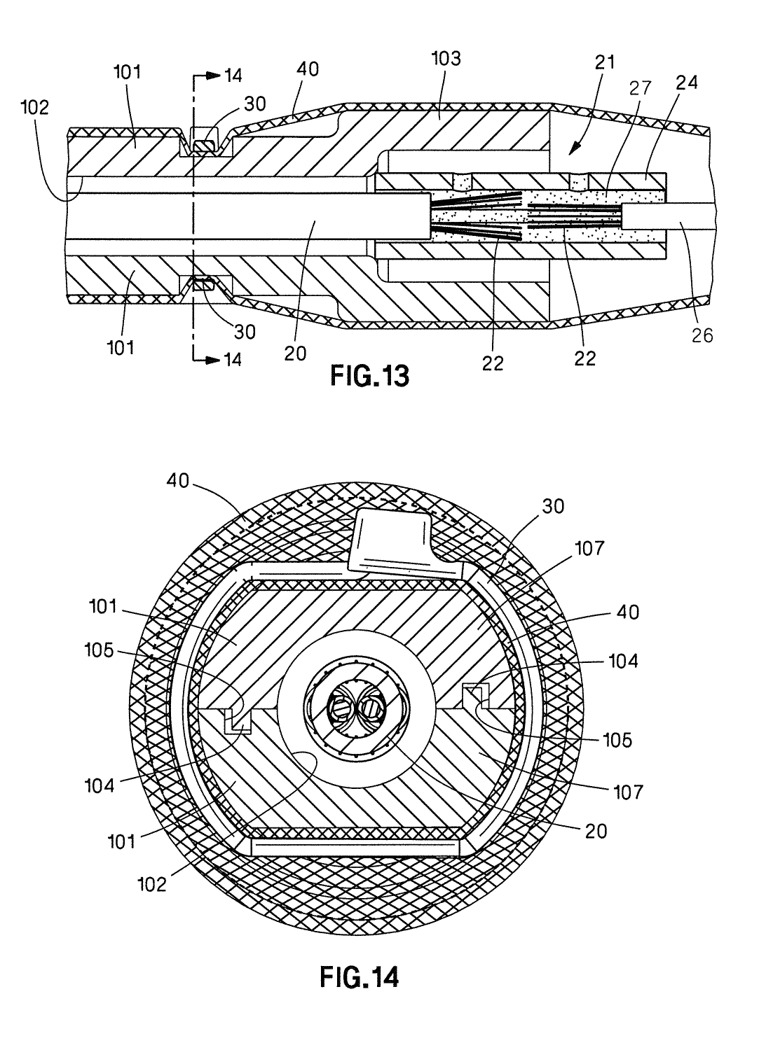

FIGS. 8-12 show the structure of the transition 21. The transition is formed by stripping back a portion of the fiber optic cable 20, being certain to expose some of the strength members 22. Then, breakout tubes 26 are placed over the fibers 23 depending on how the fibers 23 are to be divided in the transition 21. Next, a rigid transition shell 24 is placed over the transitional area. Finally the glue or epoxy 27 is inserted into the transitional area inside the rigid transition shell 24. In one embodiment, the glue or epoxy 27 can be inserted into the transitional area via holes 25 located in the rigid transition shell. In one embodiment, the rigid shell 24 can be covered by a heat shrink after the epoxy or glue has been inserted and has hardened. Once this structure is complete, pulling on the rigid transition shell transfers the load to the strength members of the fiber optic cable via the hardened glue or epoxy 27 in the transitional area. As such, and as shown by FIGS. 13 and 14, by having the cup 103 of the pulling eye insert 100 enclose and engage the transition 21, the pulling load is transferred to the strength members 22 of the fiber optic cable as opposed to the outer jacket of the fiber optic cable.

While particular embodiments and applications of the present invention have been illustrated and described, it is to be understood that the invention is not limited to the precise construction and compositions disclosed herein and that various modifications, changes, and variations may be apparent from the foregoing without departing from the spirit and scope of the invention as described.

1. A pulling eye insert for a pulling assembly comprising:
a channel configured to encircle a cable; and
a cup integrally connected to the channel and configured to enclose and engage a transition of the cable.

2. The pulling insert of claim 1 wherein the insert comprises two halves.

3. The pulling insert of claim 2 wherein the halves are identical.

4. The pulling insert of claim 3 wherein each half has a semi-cylindrical wall which forms the channel when the halves are joined together, the semi-cylindrical wall further having a groove on a first end face and a raised ridge on an opposite end face.

5. A method of using a pulling eye insert formed of two halves and comprising a channel integrally connected to a cup to pull a pre-connectorized cable assembly, the method comprising:
enclosing a cable and transition with the pulling eye insert halves such that the channel encircles the cable and the cup encloses and engages the transition;
enclosing any connectors, breakout tubes, and the pulling eye insert with a mesh pulling sleeve;
securing the two halves together and securing the mesh sleeve to the pulling eye insert by encircling the pulling eye insert with at least one nylon tie over the mesh pulling sleeve.

6. The method of claim 5 further comprising enclosing the pulling eye insert, nylon ties, and mesh pulling sleeve with a heat shrink.

7. The method of claim 6 further comprising enclosing a lanyard with the heat shrink.
